(19) United States
(12) Patent Application Publication
(10) Pub. No.: US 2026/0320669 A1
(43) Pub. Date: Oct. 15, 2026

(54) ADVISORY COMMERCE SYSTEM AND METHOD

(71) Applicant: Topomer OU, Tallinn (EE)

(72) Inventors: Gofran Jemai, Guadalajara (ES); Héctor Zamborain Rodriguez, Riyadh (SA)

(21) Appl. No.: 19/646,402

(22) Filed: Apr. 13, 2026

Related U.S. Application Data
(60) Provisional application No. 63/787,598, filed on Apr. 11, 2025.

(51) Int. Cl. G06Q 30/0601; G06Q 20/40; G06Q 50/10

(52) U.S. Cl. CPC G06Q 30/0631; G06Q 20/401; G06Q 50/10; G06Q 2220/00

(57) ABSTRACT

A system (and method) for an advisory commerce system that enables interactive product recommendations between the users and the advisors within a social commerce platform is presented. The system integrates with the e-commerce platform via a plugin, enabling the users to receive tailored shopping suggestions while fostering a community-driven shopping experience. The platform enhances online shopping experience by making it cheaper, easier, and more interactive for both the users and the retailers.

### CROSS-REFERENCE TO RELATED APPLICATIONS

This application claims priority to a provisional US application no. 63/787,598 filed on Apr. 11, 2025. The entire content of this application is incorporated by reference herein.

### FIELD OF THE INVENTION

The present invention generally relates to the field of facilitating online, digital, mobile, retail purchasing and the like. More particularly, the present invention relates to methods and systems of providing a personalized shopping assistant to aid in electronic commerce shopping for enhancing the online shopping experience.

### BACKGROUND OF THE INVENTION

E-commerce recommendation systems are largely driven by automated AI algorithms or static affiliate links. These systems provide scalability to the e-commerce websites. However, these systems lack the authenticity and personalized touch of human interaction. Furthermore, existing affiliate systems often struggle with "attribution leakage," where an advisor provides the value advice, but the transaction occurs in a way that the advisor cannot be verified or compensated for the advice.

The e-commerce industry is saturated with countless online stores, making it difficult for consumers to find personalized recommendations that match their tastes and budgets. Additionally, online shoppers struggle with trust issues when seeking advice on online purchases. Existing platforms offer automated recommendations, but they lack a social aspect where users can get personalized help from real people they trust. Advisors exist, but their services are expensive, making them inaccessible to many online shoppers.

U.S. Patent US6865546B1 assigned to Amazon discloses a system for providing product recommendations within an electronic commerce environment based on user preferences and interaction data. The system facilitates generation of product suggestions for users who are browsing within an online marketplace and assists in guiding purchasing decisions through recommendation algorithms. However, the disclosed system primarily relies on automated recommendation mechanisms and does not provide a framework that provides structured consultation interactions between users and validated shopping assistant. Further, the system fails to disclose mechanisms for recording advisory interactions, capturing explicit approval events from users, or associating advisory guidance with downstream purchase transactions occurring outside the primary commerce environment.

U.S. Patent Publication US20140089130A1 assigned to Wal Mart discloses techniques for generating and presenting product recommendations within an e-commerce platform using user activity data and recommendation models. The system focuses on improving product discovery within the same commerce platform by analyzing user interactions and behavioral data. However, the disclosed system does not address a social commerce environment that facilitates interactive consultation between the customers and the advisors. Additionally, the reference fails to disclose mechanisms for detecting a purchase transaction occurring within the external commerce platforms or attributing such transactions for advisory interactions conducted within a separate advisory platform.

US Publication US20080208705A1 assigned to Interactive Luxury Solutions LLC discloses a personalized shopping assistant that provides purchasing suggestions to a shopper. Although, the system disclosed provides a system in which a selection of a product on the list is received from the shopper so that a purchase request for the product may be initiated on behalf of the shopper using stored financial-account information. However, the system fails to disclose the shopping assistant that provides suggestions based on purchaser customization.

### SUMMARY OF THE INVENTION

Different embodiments of the system and method of this invention solve this prior art problem by providing an advisory commerce system that provides a personalized product or service recommendations social network designed to connect multiple users or customer with multiple advisors that offers free or paid or subsidized fashion advice. The system integrates with an e-commerce platform via a plugin, enabling the users to receive tailored shopping suggestions while fostering a community-driven shopping experience. The platform enhances online shopping experience by making it cheaper, easier and more interactive for both consumers and retailers.

In certain embodiments of the system each user of the multiple users creates a profile detailing their style preferences, sizes and shopping goals. The users browse or request advice from advisors on specific outfits or brands. The integrated plugin allows the users to purchase suggested items directly from partnered online stores. The users share purchases, reviews and recommendations with their network, fostering engagement.

The disclosed system applies to digital commerce environments in which advisory interactions influence purchasing decisions of the users based on the advisory interactions of the users with the personal shoppers. The architecture enables verifiable attribution of transactions to advisory activity across multiple commercial domains, including but not limited to fashion, beauty, electronics, travel, real estate and service marketplaces.

The system may be implemented using conventional mobile computing devices, web-based commerce infrastructures and distributed cloud environments, thereby demonstrating practical technical applicability within existing industrial ecosystems.

An objective of the illustrative embodiment of the present invention is to provide a social commerce platform based on a pre-defined execution sequence used for transforming advisory interaction into a technically verifiable commercial transaction that enables automatic compensation without relying on conventional affiliate tracking alone.

Another objective of the illustrative embodiment of the present invention is to provide an advisory system that synchronizes independent computing systems into a unified advisory-driven commerce workflow.

Another objective of the illustrative embodiment of the present invention is to provide a system that provides personalized shopping assistance in which the users can interact with the verified advisors who provide recommendations for free.

Another objective of the illustrative embodiment of the present invention is to provide a system that integrates social network in which the users follow, like and engage with fashion influencers, stylists and friends. Yet another objective of the illustrative embodiment of the present invention is to provide an e-commerce plugin that integrates with online stores to make purchasing seamless for the users.

Another objective of the illustrative embodiment of the present invention is to provide a social shopping network that introduces a human-centered approach where the real people offer free guidance with respect to shopping.

Yet another objective of the illustrative embodiment of the present invention is to provide a system that provides verified user reviews and a rating system to ensure high-quality recommendations. Another objective of the illustrative embodiment of the present invention is to provide a system that seamlessly integrates e-commerce website in which the users can get advice and purchase within the same ecosystem.

Another objective of the illustrative embodiment of the present invention is to provide a trustworthy and personalized online shopping system that creates a more authentic shopping experience in which advisors don’t sell. Yet another objective of the illustrative embodiment of the present invention is to provide an online shopping platform that benefit from increased sales through direct integration with the e-commerce platform. Another objective of the illustrative embodiment of the present invention is to provide a platform that helps influencers, advisors , stylists and fashion enthusiasts to monetize their expertise by building a trusted community.

Another objective of the illustrative embodiment of the present invention is to provide a platform that develops an interactive community where the users share and engage through multimedia posts including images, videos, texts. Yet another objective of the illustrative embodiment of the present invention is to provide a platform that facilitates purchasing and personalized consultations by connecting clients with advisors through a secure payment system like Stripe, etc.

Another objective of the illustrative embodiment of the present invention is to provide a social system that ensures smooth communication with real-time messaging that supports text and image exchanges. Yet another objective of the illustrative embodiment of the present invention is to provide an efficient notification system to keep users informed about interactions on their posts and messages. Another objective of the illustrative embodiment of the present invention is to provide a social commerce platform that integrates a loyalty program via WordPress, allowing clients to earn discounts based on their purchases from advisors.

Another objective of the illustrative embodiment of the present invention is to provide social commerce platform that maintains a high level of privacy by allowing users to set their accounts as public, private or universal live streaming. Yet another objective of the illustrative embodiment of the present invention is to provide a social commerce platform that enables the users to manage their profiles such as but not limited to edit personal information, change passwords, update profile pictures, etc. Another objective of the illustrative embodiment of the present invention is to provide an advisory commerce system that offer transaction tracking so that users can view their sent and received payments. Yet another objective of the illustrative embodiment of the present invention is to provide social commerce platform that implements moderation tools such as user blocking and reporting inappropriate content.

In the preferred embodiment of the present invention, the system provides an advisory commerce system that enables a customer to perform shopping on an external commerce platform based on an advice of an advisor. The advisory commerce system comprising a social commerce platform or platform configured to enable interaction between a plurality of customer and a plurality of authenticated advisors. The social commerce platform includes a customer profile creating module configured to create a customer profile of a customer including customer identification (customerID), name, preferences and budgets of each of the plurality of customers. The social commerce platform includes an advisor profile creating module configured to create an advisor profile of an advisor including consultant identification (consultantID), name, authentication status and guidance capability of each of the authenticated advisors.

The social commerce platform includes a consultation session creating module configured to facilitate a consultation session between the customer and an advisor selected by the user, wherein the consultation session creating module generates a unique SessionID linked to the customerID and the ConsultantID. The social commerce platform supports messaging, posting of images, videos and text content and user engagement interactions including likes, comments and follows. The social commerce platform includes a randomized or preference-learning content presentation interface configured to collect user feedback signals.

Each of the authenticated advisors is verified based on professional credentials, experience or influence metrics and further displayed with a visual trust indicator within a user interface.

The advisory commerce system includes a consultation session manager in communication with the social commerce platform configured to record advisory interactions, user constraints and approval events associated with the consultation session. The consultation session manager configured to generate a consultation session for a user and an advisor, further wherein the consultation session is cryptographically timestamped.

The advisory commerce system includes a detection plugin deployable within the external commerce platform and in communication with the social commerce platform and the consultation session manager. The detection plugin including an advisor identifier configured to identify the advisor in real-time and further detects an authentication event of the advisor via a secure identity token. The detection plugin is further configured to perform a real-time API lookup during a checkout process of the external e-commerce platform to validate the SessionID.

Further, the detection plugin includes a relationship manager configured to establish a verifiable causal relationship of the advisor and the customer based on the secure identity token and further the advisor provides one or more suggestions with respect to purchase decisions to the users. The secure identity token includes at least one of a cryptographically signed session token, an encrypted browser cookie or a URL parameter with signature validation.

Further, the detection plugin includes a purchase detector configured to detect a purchase executed by the customer or the user based on the one or more suggestions of the advisor. The detection plugin includes a link generator to generate a cryptographically verifiable advisory-causality link between the advisor and the user or the customer.

The detection plugin includes a transaction attribution engine configured to associate the purchase with the consultation session based on the cryptographically verifiable advisory-causality link for generating a verified transaction for the user. The detection plugin validates an encrypted identity token associated with the authenticated advisor. The transaction attribution engine stores attributed transactions in an immutable ledger. The transaction attribution engine verifies chronological ordering of the consultation session, the approval event and the detected purchase prior to generation of a commission.

The detection plugin operates as a server-side module, client-side script, middleware component or browser extension. The detection plugin supports multiple external commerce platforms. The detection plugin is further configured to generate a unique transaction identifier associated with the advisor and the consultation session. The detection plugin communicates with the social commerce platform through authenticated application programming interfaces secured by encrypted tokens.

The advisory commerce system includes a commission generation unit that includes a compensation recording module configured to calculate a financial compensation based on the verified transaction. The commission generation unit includes a commission recording module configured to record a commission for the advisor based on the financial compensation and predefined rules and agreements.

The commission values or the financial compensation requires an approval event from the user prior to the detected purchase and further is determined using predefined percentage rules or promotional parameters. The commission generation module supports configurable commission rules specific to individual external commerce platforms.

The advisory commerce system includes a shopping module for enabling the customer to perform shopping on an external commerce platform based on the advice of an advisor. The commission generation unit triggers dynamic generation of a unique promo code after the purchase action is detected, the promo code being programmatically associated with the ConsultantID and the specific TransactionID.

In the illustrative embodiment of the present invention, the advisory commerce system includes a peer interaction interface configured to collect preference feedback on presented content. In one aspect of the illustrative embodiment of the present invention, the system further includes a fraud-prevention logic configured to reject duplicated or invalid transactions. The communications between system components are secured using encrypted network protocols. In one aspect of the illustrative embodiment of the present invention, the system provides a performance analytics module configured to evaluate a performance of the each of the plurality of advisors. In another embodiment of the present invention, the system further comprises a reputation scoring subsystem configured to adjust visibility or ranking of each of the plurality of advisors based on historical transaction outcomes.

In another aspect of the illustrative embodiment of the present invention, the system provides the social commerce platform that enables profile creation and modification. The advisory commerce system operates across distributed cloud infrastructure. The transaction data and the commission data are stored within a tamper-resistant or cryptographically secured data structure.

The architecture supports operation across multiple industries including fashion, beauty, electronics, travel, real estate or service marketplaces. The components of the social commerce platform are deployed within a distributed cloud environment configured for horizontal scalability and fault tolerance.

In one aspect of the illustrative embodiment of the present invention, a method enabling a user to receive tailored shopping suggestions on an external commerce platform based on advisory is disclosed. The method includes a step of initiating a consultation session between a user and an advisor within a social commerce platform. The method includes a step of receiving user constraints and transmitting advisory content from the advisor. The method includes a step of recording an approval event associated with the advisory content.

The method also includes a step of detecting a purchase executed by the advisor via a detection plugin operating in an external commerce platform. The method includes a step of associating the detected purchase with the consultation session using a transaction attribution engine. The method includes a step of generating a commission for the advisor using a commission generation module.

The method further includes a step of notifying the user and the advisor upon successful generation of the commission. The method further comprising storing the commission in a payout ledger. The method further comprises preventing generation of the commission when the detected purchase is not associated with a valid approval event.

Another aspect of the illustrative embodiment of the present invention is to provide a detection plugin that acts as a bridge between a social network and a partner store. When a personal shopper provides advice, a unique SessionID is created. As the shopper or user navigates to a store, the system carries a secure identity token via encrypted cookies or signed URLs.

The detection plugin detects when a purchase is made, hashes the cart contents to ensure they match the advice given and transmits this "proof of advice" back to a central ledger. This creates a verifiable, immutable link between a human interaction and a financial transaction. By using dynamic promo code generation, the system ensures that compensation is only triggered when a verifiable consultation has occurred, thereby reducing fraud and increasing the authenticity of the shopping experience.

In another aspect of the illustrative embodiment of the present invention, the detection plugin is a computer-implemented module that is embedded within a partner e-commerce platform. The partner e-commerce platform is implemented as a software plugin module distributed through a web-based plugin distribution repository, including the WordPress plugin marketplace. The plugin is installable within the WordPress-based e-commerce environments, including but not limited to WooCommerce implementations, and upon installation, the detection plugin is configured to detect advisor-initiated purchase activity, validate secure authorization credentials associated with a consultation session, transmit transaction metadata to a remote attribution service, and enable automated commission generation linked to verified advisory causality

The availability of the client application through a mobile application marketplace and the availability of the detection component through a web-based plugin distribution repository demonstrate practical industrial deployment of the disclosed computer-implemented system across mobile computing ecosystems and web-based commercial transaction infrastructures.

In another apect of the illustrative embodiment of the present invention, the interactive advisory system is a distributed computer system composed of client applications, mobile and web, centralized backend services, real-time communication infrastructure, external partner e-commerce platforms and a store-embedded detection plugin. All components communicate through secured network protocols and form a single logical social-commerce execution environment. The deployment of the system occurs in cloud infrastructure supporting horizontal scaling, redundancy, and geographic distribution.

In another aspect of the illustrative embodiment of the present invention, the system maintains a directed interaction graph representing follows, likes, comments, consultation relationships, and engagement frequency. The graph analytics influence content visibility, shopper trust ranking, and recommendation ordering.

In certain embodiments, the system further comprises a transaction execution system in which the user transfers funds to the platform prior to purchase. The platform temporarily holds the funds, and anadvisor executes the purchase transaction on behalf of the user within one or more external commerce platforms. The system subsequently distributes funds between the merchant, the advisor, and the platform based on the verified transaction.

In certain embodiments, the system establishes a verifiable causal relationship between a consultation session, a user approval event, and a corresponding purchase transaction detected within an external commerce platform.In certain embodiments, the platform includes a fund custody module configured to receive and temporarily hold user funds prior to execution of a purchase transaction. Upon user approval of advisory recommendations, the system enables anadvisor to execute the purchase using the held funds via an integrated detection plugin within external commerce platforms.

In certain embodiments, the purchase transaction is executed by the advisor on behalf of the user, rather than directly by the user, following approval of advisory recommendations. In certain embodiments, the detected transaction corresponds to a purchase executed by the advisor using platform-controlled funds, thereby enabling both transaction execution and attribution within a unified system.

In certain embodiments, the system verifies chronological consistency between the consultation session, the approval event, and the purchase transaction, and rejects attribution if the sequence is invalid.

Although the invention is described in terms of exemplary embodiments, the modular architecture allows it to be adapted and extended to various educational, academic environments and teaching conditions.

The features described can be applied individually or in combination across different embodiments, making the system highly scalable, secure and efficient in transforming how smart systems are managed through real-time automation and intelligent decision-making.

Other objectives and aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only and that changes may be made in the specific construction illustrated and described within the scope of the appended claims.

Although, the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the illustrative embodiment of the present invention should not be limited by any of the above-described exemplary embodiments.

### BRIEF DESCRIPTION OF THE DRAWINGS

The teachings of different embodiments of the present invention can be readily understood by considering the following detailed description in conjunction with the accompanying drawings of the various embodiments of the invention, in which:

FIG. 1A illustrates an advisory commerce system for associating an advisory interaction with an external commercial transaction in accordance with one embodiment of the present invention;

FIG. 1B illustrates a schematic view of the advisory commerce system for associating an advisory interaction with an external commercial transaction in accordance with one embodiment of the present invention;

FIG. 2 illustrates a MVVM architecture for explaining a front-end module of the advisory commerce system in accordance with one embodiment of the present invention;

FIG. 3A illustrates a MVC architecture Node.js for explaining a backend module of the advisory commerce system in accordance with one embodiment of the present invention;

FIG. 3B illustrates a Laravel architecture for explaining the backend module of the advisory commerce system in accordance with one embodiment of the present invention;

FIG. 4 illustrates a consultation workflow of the advisory commerce system in accordance with one embodiment of the present invention;

FIG. 5 illustrates a method for associating an advisory interaction with an external commercial transaction in accordance with one embodiment of the present invention;

FIG. 6 illustrates a system of one embodiment of the present invention; and

FIG. 7 illustrates major components of a server in one embodiment of the present invention.

### DETAILED DESCRIPTION OF THE INVENTION

The illustrative embodiment of the invention discloses an advisory commerce system that is a social network advisory platform for personalised product and service recommendations. The system connects the users with a number of advisors who provide advice to the users for buying products or services. The platform integrates with existing e-commerce systems through a plugin, enabling users to receive tailored shopping suggestions in real time. The system facilitates interactive advisory sessions while supporting a community-driven shopping experience. The platform aims to simplify online shopping by making it more accessible, efficient, and engaging for both consumers and retailers.

The disclosed system is applicable to digital commerce environments where advisory interactions influence purchasing decisions of the users. The architecture supports attribution of transactions to advisory activities across multiple commercial domains including fashion, beauty, electronics, travel, real estate, and service marketplaces. The system may be implemented using conventional mobile devices, web-based commerce infrastructures, and distributed cloud environments, thereby demonstrating practical applicability within existing industrial ecosystems.

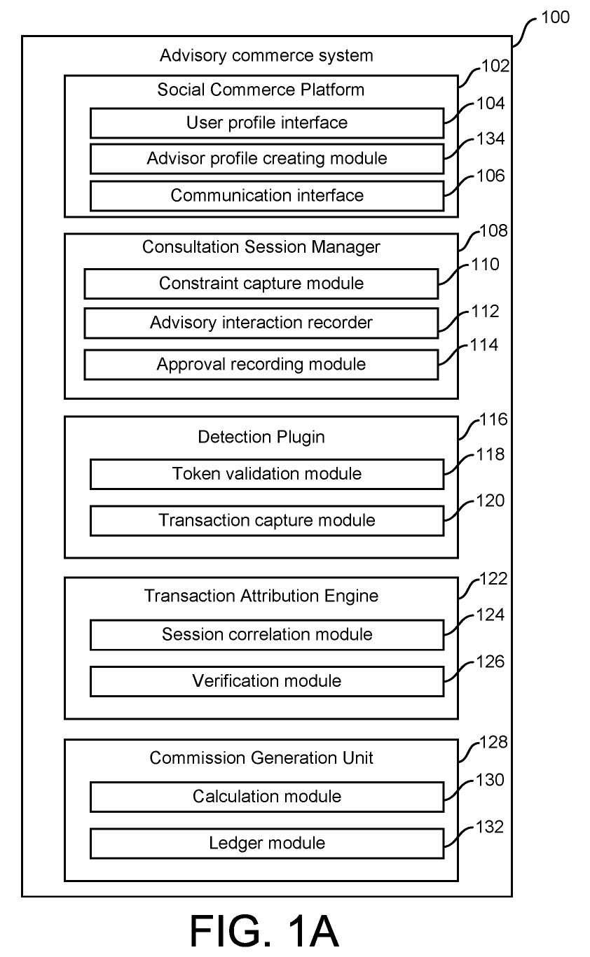

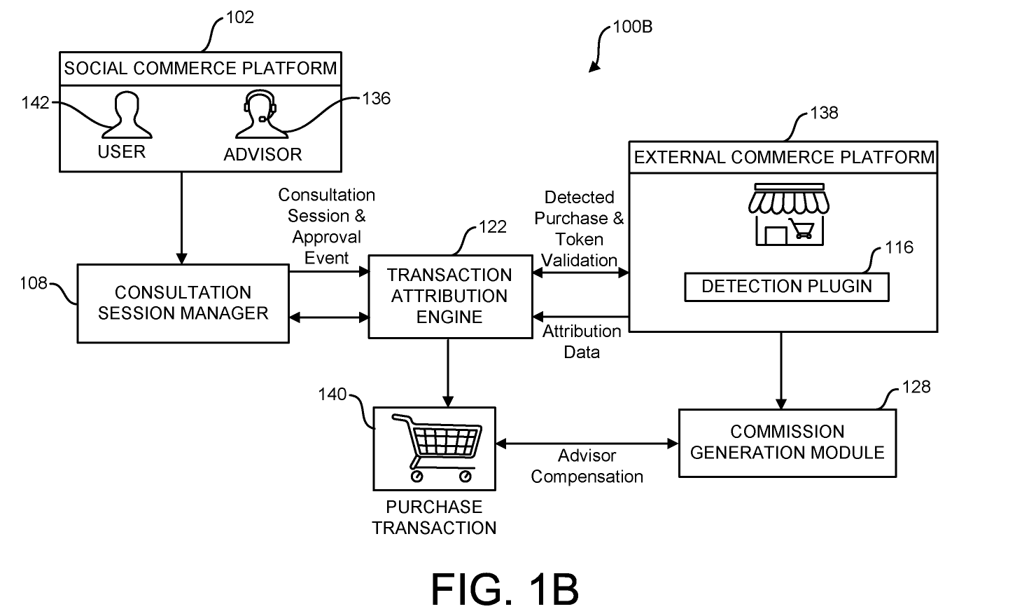

FIG. 1 A illustrates an advisory commerce system 100 configured to associate an advisory interaction with an external commercial transaction. The advisory commerce system 100 provides a technological framework that enables advisory interactions occurring within a social commerce environment to be programmatically linked with commercial transactions executed on an external commerce platform. In particular, the system 100 allows the authenticated advisors to provide curated recommendations to the users and enables the system to attribute downstream purchases to those advisory interactions.

The architecture ensures that advisory activity occurring within a consultation session can be reliably associated with a later purchase transaction. By implementing controlled interaction channels, session identifiers and attribution verification mechanisms, the system 100 establishes a verifiable association between advisory interactions and commercial transactions. As illustrated in FIG. 1A, the system integrates a social commerce platform 102, a consultation session manager 108, a detection plugin 116 deployed within an external commerce platform, a transaction attribution engine 122 and a commission generation module 128.

The social commerce platform 102 serves as a primary interaction environment in which users and authenticated advisors communicate and exchange advisory content. The social commerce platform 102 enables the creation of user profiles, facilitates advisory consultations and records advisory interactions between the users and authenticated advisors.

The social commerce platform 102 further includes a user profile interface 104 configured to store user preference data associated with individual users. Such preference data may include style preferences, product categories, budget ranges, size attributes or other contextual constraints relevant to purchasing decisions. By maintaining structured preference data, the user profile interface 104 enables the advisors to deliver recommendations tailored to user requirements. The stored preference data may also be referenced during consultation sessions to inform advisory decisions and enhance recommendation accuracy.

The social commerce platform 102 further includes a communication interface 106 configured to facilitate advisory exchanges between the users and the authenticated advisors. The communication interface 106 may support various forms of communication, including text messaging, multimedia messaging, interactive chat sessions or structured recommendation feeds. Through the communication interface 106, the authenticated advisors can present product suggestions, curated collections, outfit combinations or other advisory content responsive to constraints applied by the users. The communication interface 106 further allows the users to provide feedback or confirm acceptance of advisory recommendations provided by the authenticated advisors.

In the preferred embodiment of the present invention, the user selects an advisor from a list of advisors based on expertise, verification status and influence status of the authenticated advisors. The selected authenticated advisor provides advisory recommendation based on the user requirements and constraints. In certain aspects of the illustrative embodiment of the present invention, the communication interface 106 may also support persistent conversation threads, enabling the continuity of advisory interactions across multiple consultation sessions.

The advisory commerce system 100 further includes a consultation session manager 108 communicatively coupled to the social commerce platform 102. The consultation session manager 108 is configured to create and manage consultation sessions between the users and the authenticated advisors. A consultation session represents a defined advisory interaction context in which recommendations are exchanged and user feedback is recorded. The consultation session manager 108 may generate a unique session identifier corresponding to each consultation session in order to maintain traceability of advisory interactions. The session identifier allows the system 100 to associate advisory recommendations with subsequent approval events and downstream purchase transactions.

The consultation session manager 108 comprises a constraint capture module 110 configured to receive and store user constraints associated with the consultation session. The constraint capture module 110 records structured data describing user requirements that influence purchasing decisions. The user constraints may include budget limits, product categories, preferred brands, color preferences, size information, contextual usage requirements or other relevant parameters provided by the user. The captured constraints provide contextual information that guides the advisor when preparing advisory recommendations. In certain implementations, the constraint capture module 110 may also enable dynamic updates of constraints during an ongoing consultation session, allowing the advisor to refine recommendations in response to user feedback.

The consultation session manager 108 further includes an advisory interaction recorder 112 configured to record an advisory interaction between the user and the advisor occurring during the consultation session for generating a set of advisory recommendations. The advisory interaction recorder 112 maintains a structured record of advisory exchanges, including recommendations provided by the advisor and responses from the user. These records may include product identifiers, recommendation timestamps, conversation content and contextual metadata associated with the advisory communications. By recording the advisory interactions, the system 100 preserves evidence of the advisory process that may later be used for transaction attribution. The advisory interaction recorder 112 thereby forms part of the evidentiary framework used by the system to link advisory activity with external purchase transactions.

In this embodiment, the consultation session manager 108 additionally includes an approval recording module 114 configured to record an approval event indicating acceptance of an advisory recommendation by the user. The approval event represents a confirmation that the user intends to act upon a recommendation provided by the advisor. In certain aspects of the illustrative embodiment of the present invention, the approval event may be generated when the user explicitly confirms a recommendation or selects a recommended product. The approval recording module 114 stores the approval event together with the consultation session identifier and the associated advisory interaction record. The approval event thus provides a reference point that establishes the user’s acknowledgement of the advisor’s recommendation prior to the purchase transaction.

The advisory commerce system 100 further interacts with an external commerce platform through a detection plugin 116 deployed within the external commerce platform. The detection plugin 116 enables the system to detect purchase activity that occurs outside the social commerce platform 102. The external commerce platform may include third-party e-commerce websites, online marketplaces or retailer-operated commerce portals. By deploying the detection plugin 116 within the external commerce platform, the system 100 can identify purchase transactions that correspond to advisory recommendations previously provided during the consultation session. This capability enables attribution of external purchases to advisory interactions recorded within the system.

The detection plugin 116 includes a token validation module 118 configured to validate an identity token associated with the advisor and the consultation session. The identity token may be embedded within a transaction request or transmitted through a secure communication channel during the checkout process. The token validation module 118 verifies that the identity token corresponds to a valid consultation session and an authenticated advisor. This validation step ensures that only legitimate advisory interactions are considered during the transaction attribution process. By verifying the authenticity of the identity token, the detection plugin 116 prevents unauthorized attribution of purchase transactions.

In certain embodiments, the detection plugin 116 is further configured to enable execution of purchase transactions performed by the advisor on behalf of the user, including validation of session-linked authorization and synchronization with platform-controlled payment flows.In certain embodiments, the purchase transaction is executed by the advisor on behalf of the user using platform-controlled funds, rather than being directly executed by the user. The advisor interacts with the external commerce platform 138 through the detection plugin 116, enabling the system 100 to maintain control over transaction execution while preserving compatibility with third-party commerce infrastructures.

The detection plugin 116 further comprises a transaction capture module 120 configured to capture transaction data associated with a detected purchase transaction. The captured transaction data may include a purchase value, store identifier, product identifiers and a transaction timestamp based on the purchase. The transaction capture module 120 records this data when a purchase transaction is executed within the external commerce platform. The captured data is subsequently transmitted to other components of the advisory commerce system 100 for attribution analysis. In certain aspects of the illustrative embodiment of the present invention, the transaction capture module 120 may also capture additional metadata relevant to validating the purchase transaction.

The captured transaction data is provided to a transaction attribution engine 122 communicatively coupled to both the detection plugin 116 and the consultation session manager 108. The transaction attribution engine 122 is configured to associate the detected purchase with the consultation session using an advisory-causality link. This association is performed by correlating the captured transaction data with previously recorded consultation session records and approval events. The attribution process determines whether the purchase transaction occurred as a result of the advisory interactions provided by the advisor. By performing this analysis, the transaction attribution engine 122 establishes a programmatic link between the advisory interactions and the external commercial activity.

The transaction attribution engine 122 comprises a session correlation module 124 configured to match the captured transaction data with a consultation session identifier associated with the consultation session. The session correlation module 124 identifies whether the transaction is linked to a previously recorded consultation session by examining the identity tokens, the session identifiers and the approval event records. The correlation process ensures that only transactions associated with a valid consultation session are attributed to the advisory interaction. The session correlation module 124 further evaluates whether the purchased item corresponds to a recommendation previously recorded during the advisory interaction.

In certain embodiments, the advisory commerce system 100 further includes a fund custody module configured to receive and temporarily hold funds provided by the user prior to execution of a purchase transaction. The held funds are selectively released upon successful validation of the transaction and distributed between the external commerce platform 138, the advisor, and the system 100 based on predefined allocation rules.

The transaction attribution engine 122 further comprises a verification module 126 configured to verify a chronological validity between the consultation session, the approval event and the detected purchase transaction. The verification module 126 confirms that the purchase transaction occurred after the advisory interaction and the corresponding approval event. This chronological verification ensures that the purchase transaction logically follows the advisory recommendation and is therefore eligible for attribution. If the chronological conditions are not satisfied, the system may reject attribution of the transaction to the consultation session. The verification module 126, therefore, ensures the integrity of the advisory-causality association.

The advisory commerce system 100 further includes a commission generation module 128 communicatively coupled to the transaction attribution engine 122. The commission generation module 128 is configured to calculate and record financial compensation for the advisor based on the associated purchase transaction. Once the transaction attribution engine 122 verifies the advisory-causality link, the commission generation module 128 initiates compensation processing. The commission generation module 128 enables the system to reward the advisors whose recommendations lead to successful purchase transactions. The commission generation module 128 thereby incentivizes high-quality advisory interactions within the social commerce platform 102.

The commission generation module 128 includes a commission calculation module 130 configured to determine a commission value based on a predefined commission rules. The calculation module 130 may consider various parameters, including purchase value, merchant-specific commission structures, product categories or promotional agreements. The calculated commission value represents the financial reward assigned to the advisor for facilitating the purchase transaction. In certain aspects of the illustrative embodiment of the present invention, the commission calculation may also incorporate dynamic incentive models that adjust compensation based on advisor performance metrics.

The commission generation module 128 further may include a commission ledger module 132 configured to record the calculated commission together with transaction identifiers and payout status information for the advisor to generate a financial compensation for the advisor and enabling the user to perform shopping on the external commerce platform. The ledger module 132 maintains a persistent record of commission events associated with advisory interactions and attributed purchase transactions. These records may be used for financial reconciliation, advisor compensation tracking and auditing purposes. The ledger module 132 further maintains historical commission records that enable long-term performance analysis of the advisors. By maintaining a structured ledger of attributed transactions and commissions, the system ensures transparent tracking of advisory-driven commercial activity.

Collectively, the components of the advisory commerce system 100 cooperate to associate a consultation session with a detected purchase transaction, thereby linking an advisory interaction with an external commercial transaction. Through the coordinated operation of the social commerce platform 102, the consultation session manager 108, the detection plugin 116, the transaction attribution engine 122 and the commission generation module 128, the system provides a reliable mechanism for attributing commercial outcomes to the advisory interactions. This architecture enables the advisors to influence purchasing decisions while ensuring that resulting transactions can be accurately identified and associated with the advisory activity that led to the purchase.

FIG. 1 B illustrates a schematic view of the advisory commerce system 100 configured to associate an advisory interaction with an external commercial transaction in accordance with an illustrative embodiment of the present invention. The system 100 integrates a social commerce environment with transaction attribution and commission generation mechanisms that collectively establish a verifiable relationship between advisory guidance and a resulting purchase. The architecture enables the users to receive personalized recommendations from the authenticated advisors while allowing the platform to detect purchases performed within external commerce environments. Through coordinated operation of the illustrated modules, the system 100 associates advisory interactions with downstream commercial transactions.

In one aspect of the illustrative embodiment of the present invention, the system 100 includes a social commerce platform 102 that provides the primary interface through which users and advisors interact. The social commerce platform 102 enables collaborative product discovery and consultation activities within a digital environment. The platform may be implemented as a web application, a mobile application or a hybrid platform supporting multiple client devices. The platform also manages the authentication of the advisors and facilitates structured consultation sessions between the users and the advisors.

The social commerce platform 102 further includes a user profile interface 104 configured to store and manage user-specific information. The user profile interface 104 maintains preference data, including budget constraints, brand preferences, product categories, size information and contextual purchasing requirements. Such information may be used to personalize advisory interactions and improve the relevance of recommendations provided by the advisors. The stored preference data may also support preference learning mechanisms that enhance future advisory matches.

The social commerce platform 102 also includes a communication interface 106 configured to facilitate real time or asynchronous communication between the users and the authenticated advisors. The communication interface 106 may support messaging, multimedia exchange, recommendation cards or structured advisory prompts. Through this interface, the advisors can provide curated product suggestions, outfit combinations or contextual purchasing guidance to the users. The communication interface 106, therefore, forms the primary channel through which advisory content is exchanged during consultation sessions.

The system 100 further comprises a consultation session manager 108 communicatively coupled to the social commerce platform 102. The consultation session manager 108 is responsible for creating, managing and terminating consultation sessions between users and advisors. When a user requests guidance, the consultation session manager 108 generates a session identifier that uniquely identifies the consultation interaction. The session identifier enables subsequent association of advisory activity with the downstream purchase transactions.

The consultation session manager 108 may include a constraint capture module 110 configured to receive and record a list of user constraints associated with a consultation request. The constraint capture module 110 collects information such as price limits, brand preferences, size parameters, product categories and contextual needs such as event-specific clothing or seasonal products. This captured information is stored as consultation metadata and assists the advisor in generating relevant recommendations aligned with user requirements.

The consultation session manager 108 further includes an advisory interaction recorder 112 configured to record advisory communications occurring during the consultation session. The advisory interaction recorder 112 stores recommendation messages, product references, links or curated suggestion lists provided by the advisor. The recording of such interactions ensures that the advisory guidance provided during the consultation session can later be evaluated and associated with potential purchasing activity.

The consultation session manager 108 also includes an approval recording module 114 configured to record an approval event indicating acceptance of an advisory recommendation by the user. The approval event may be triggered when the user confirms interest in a recommended product or selects a suggested item within the platform interface. The approval event is timestamped and linked to the consultation session identifier. This event establishes evidence that the advisory recommendation influenced the user’s purchase intent.

In order to detect downstream commercial transactions, the system 100 includes a detection plugin 116 deployable within an external commerce platform 138. The detection plugin 116 operates as an integration component capable of monitoring purchasing activity occurring within third-party online stores. The detection plugin 116 may be implemented as a server-side extension, middleware component or client-side script embedded within the commerce environment. Through such integration mechanisms, the detection plugin 116 identifies purchase events that may correspond to advisory recommendations generated within the social commerce platform.

The detection plugin 116 includes a token validation module 118 configured to validate an identity token associated with the advisor and the consultation session. The identity token may be embedded in a referral link, cookie or authentication request transmitted from the social commerce platform. The token validation module 118 may verify cryptographic signatures or authentication metadata to ensure that the token originates from a legitimate consultation session. This validation step prevents fraudulent or duplicated attribution of transactions.

The detection plugin 116 further may include a transaction capture module 120 configured to capture transaction data associated with detected purchase events. The transaction capture module 120 records information such as purchase value, product identifiers, store identifiers and transaction timestamps. Additional transaction metadata may also be captured to support verification processes and attribution logic. The captured transaction data is subsequently transmitted to other system components for evaluation and association.

The system 100 further comprises a transaction attribution engine 122 communicatively coupled to both the detection plugin 116 and the consultation session manager 108. The transaction attribution engine 122 evaluates whether a detected purchase transaction corresponds to a previously recorded consultation session. Through this evaluation process, the engine establishes an advisory-causality relationship between advisory guidance and a commercial transaction. This mechanism ensures that purchases influenced by advisors can be reliably attributed to the advisory interaction.

The transaction attribution engine 122 includes a session correlation module 124 configured to correlate captured transaction data with a consultation session identifier. The session correlation module 124 evaluates identity tokens, approval events and advisory interaction records associated with the consultation session. By matching the transaction data with these records, the module determines whether the purchase was influenced by the advisory session. This correlation mechanism forms an important aspect of the advisory attribution process.

The transaction attribution engine 122 also includes a verification module 126 configured to verify chronological validity between the consultation session, the approval event and the detected purchase transaction. The verification module 126 evaluates timestamp information associated with each event to confirm that the advisory interaction preceded the purchase event. If chronological validity conditions are not satisfied, the system 100 may reject the attribution request. This verification step ensures the integrity and authenticity of advisory-linked transactions.

Once the advisory-causality relationship has been confirmed, the system 100 activates a commission generation module 128 configured to generate financial compensation for the advisor. The commission generation module 128 calculates rewards or commissions associated with purchases attributed to the advisory recommendations. These commissions incentivize the advisors to provide high-quality guidance and actively participate in the social commerce ecosystem.

The commission generation module 128 includes a commission calculation module 130 configured to determine a commission value associated with the detected purchase. The commission calculation module 130 may apply predefined commission rules, store-specific parameters or promotional incentive structures. For example, commission rates may vary depending on product categories, partner merchant agreements or promotional campaigns. The calculated commission value represents the financial reward earned by the advisor for the attributed purchase.

The commission generation module 128 further includes a commission ledger module 132 configured to record commission data associated with the transaction. The commission ledger module 132 maintains records including transaction identifiers, advisor identities, commission values and payout status information. These records may be stored within secure databases or tamper-resistant storage structures to ensure data integrity. The commission ledger module 132, therefore, provides a reliable financial record of advisor compensation events.

In certain aspects of the illustrative embodiment of the present invention, the system 100 may also generate unique commission identifiers associated with each attributed purchase transaction. These identifiers allow tracking of commission payouts and simplify auditing of advisory-linked transactions. The commission records may further support reporting tools, advisor performance analytics and platform-level revenue sharing models. Such mechanisms contribute to the transparency and accountability of the advisory commerce ecosystem.

The integrated architecture illustrated in FIG. 1B enables the system 100 to establish a structured relationship between advisory guidance and purchase transactions occurring within external commerce environments. By combining consultation session management, transaction detection, attribution verification and commission generation processes, the system 100 ensures that advisory interactions can be reliably linked to commercial outcomes. This capability enables the creation of a scalable advisory commerce platform where advisors are incentivized based on verified purchasing behavior influenced by their recommendations.

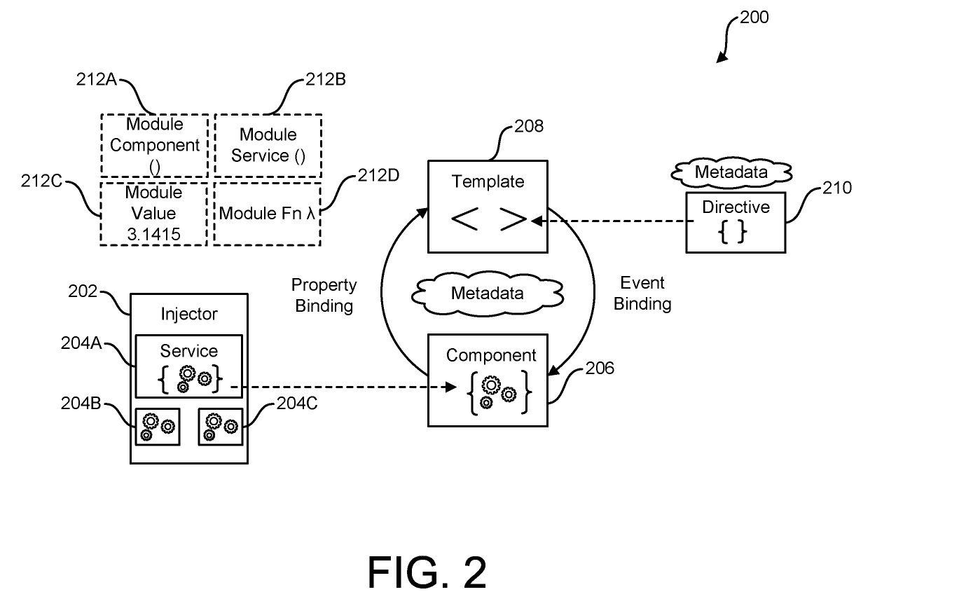

FIG. 2 illustrates a Model–View–View Model (MVVM) architecture 200 of a front-end module of the advisory commerce system. The MVVM architecture 200 provides a structured software framework that separates user interface rendering, application logic and data handling within the front-end environment of the social commerce platform 102. This separation enables efficient handling of advisory interactions between the users and the advisors during consultation sessions. The architecture improves modularity, maintainability and scalability of the frontend module. As illustrated, the architecture 200 includes an injector 202, one or more services 204A–204C, a component 206, a template 208, directives 210 and module elements 212A–212D that collectively support interactive advisory commerce functionality.

In certain aspects of the illustrative embodiment of the present invention, the injector 202 functions as a dependency management mechanism that dynamically provides application services to frontend components. The injector 202 is configured to manage object creation and ensure that required services are available to the various components of the frontend module. By utilizing the injector 202, the architecture reduces tight coupling between application components. The injector 202 further maintains a registry of service instances that are reused across multiple user interface components. This approach improves performance and simplifies application development.

The injector 202 provides access to a set of services 204A, 204B and 204C that support application functionality within the frontend module. These services may include data communication services, advisory interaction services and session management services. Each service may encapsulate logic required to interact with backend components of the advisory commerce system. For example, a service may transmit advisory recommendations, retrieve consultation session data or submit approval events generated by the user interface. The services 204A–204C thus function as intermediaries between the frontend module and backend system components.

The services 204A–204C may further maintain data structures representing the current state of consultation sessions and advisory interactions. In some implementations, these services may store temporary session information such as user constraints, advisory recommendations and approval confirmations. The services 204A–204C may also interact with application programming interfaces that connect the frontend module with the backend components of the advisory commerce system. Through these operations, the services facilitate synchronization between the user interface and system data repositories.

The MVVM architecture 200 further may include a component 206 that represents a logical unit responsible for controlling a portion of the user interface. The component 206 acts as the primary mediator between the template 208 and the application services 204A–204C. The component 206 contains presentation logic that processes user inputs and prepares data for display within the interface. For example, the component 206 may manage advisory recommendations provided by an advisor during a consultation session. The component also receives updates from the services and forwards relevant data to the template 208 for presentation.

The component 206 may also maintain application state variables that represent current advisory interactions occurring within the social commerce platform 102. These state variables may include lists of recommended products, user constraints or approval events associated with advisory recommendations. When the state of these variables’ changes, the component 206 updates the corresponding user interface elements through the template 208. This approach enables real-time updates of advisory interactions within the frontend module.

The template 208 represents the visual presentation structure of the user interface associated with the component 206. The template 208 defines how application data is displayed within the frontend interface. The template 208 includes markup structures, layout elements and data placeholders that determine how advisory recommendations, consultation messages and user constraints are presented. The template 208 receives data from the component 206 through a property-binding mechanism that ensures changes in application data are automatically reflected within the interface.

The property binding mechanism between the template 208 and the component 206 enables the user interface to display dynamic information related to advisory commerce interactions. For example, when an advisor sends a new product recommendation, the component 206 updates the relevant data model and the template 208 automatically refreshes to display the updated recommendation. This reactive interface behavior improves the responsiveness of the advisory consultation environment. The property-binding mechanism therefore ensures consistent synchronization between the data and presentation.

The MVVM architecture 200 further may include metadata structures shown in association with the component and template that describe configuration properties and operational parameters associated with the frontend components. These metadata structures may define component selectors, dependency mappings and event-handling rules used by the frontend framework. The metadata also enables the application framework to dynamically interpret component behavior during runtime. Through these metadata configurations, the MVVM architecture 200 can maintain consistent interaction patterns between different frontend modules.

The MVVM architecture 200 also includes one or more directives 210 that extend the behavior of elements defined within the template 208. The directives 210 allow developers to attach custom functionality to user interface elements without modifying the underlying component logic. In certain aspects of the illustrative embodiment of the present invention, the directives 210 may be used to implement conditional rendering, dynamic styling or event-triggered interface behavior. For example, a directive 210 may control how advisory recommendations are displayed depending on user preferences or consultation session status.

The directives 210 may further facilitate event binding between the template 208 and the component 206. Event binding allows user-generated actions within the interface to trigger application logic within the component. For instance, when a user confirms acceptance of an advisory recommendation, an event generated in the template 208 is transmitted to the component 206. The component 206 then processes the approval event and communicates the update to the backend system through the services 204A–204C to enables seamless interaction between user actions and system processes.

The MVVM architecture 200 further may include a module structure 212A–212D that organizes application components into functional groups. The module components define logical boundaries that group related functionality within the frontend module. By organizing components into modules, the architecture simplifies dependency management and improves code reusability. The module structure also enables the application to scale efficiently as additional advisory features are introduced.

In certain aspects of the illustrative embodiment of the present invention, the module structure may include module components 212A, module services 212B, module values 212C and module functions 212D. The module components 212A define interface elements and presentation controllers used within the application. The module services 212B provide reusable service logic shared across multiple components. The module values 212C may store configuration parameters or constants used throughout the application. Meanwhile, the module functions 212D implement specific operational routines required by the frontend module.

Through the combined interaction of the injector 202, services 204A–204C, component 206, template 208, directives 210 and module elements 212A–212D, the MVVM architecture 200 provides a structured framework for managing frontend operations of the advisory commerce system. This architecture supports real-time advisory interactions between users and advisors while maintaining synchronization with backend components responsible for consultation session management and transaction attribution.

Overall, the MVVM architecture 200 improves the flexibility and responsiveness of the frontend module by separating interface rendering, presentation logic and data management into independent layers. This separation enables efficient development and maintenance of user interfaces supporting advisory commerce functionality. The MVVM architecture 200 ensures that consultation sessions, advisory recommendations and user approval events can be managed dynamically within the frontend environment. Consequently, the frontend module effectively supports interactive advisory commerce experiences within the advisory commerce system 100.

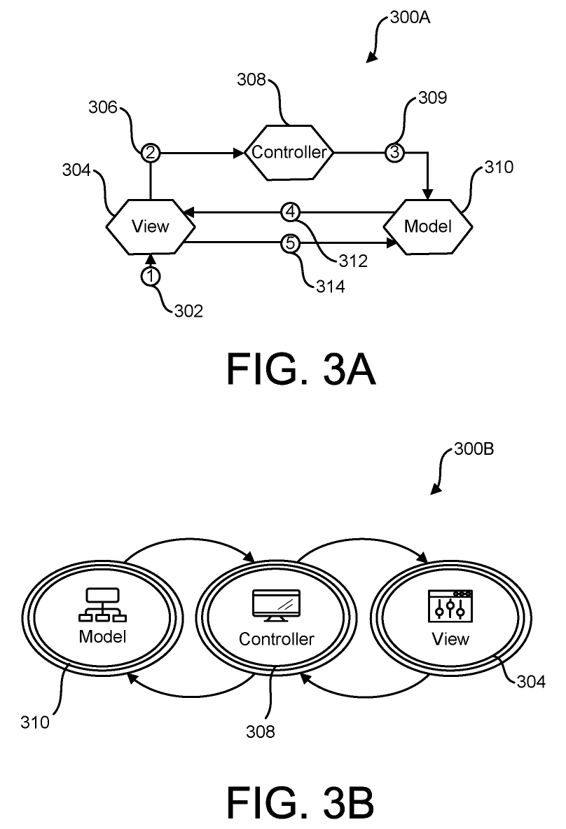

FIG. 3A illustrates a Model–View–Controller (MVC) architecture 300A implemented in a Node.js environment for a backend module of the advisory commerce system 100 in accordance with the illustrative embodiment of the present invention. The MVC architecture 300A provides a structured framework for organizing backend operations that support consultation sessions, advisory interactions, transaction attribution and commission generation. The MVC architecture 300A separates application responsibilities into three logical layers, including a view 304, a controller 308 and a model 310. This separation ensures efficient processing of backend requests and scalable management of advisory commerce workflows. In a Node.js implementation, asynchronous processing mechanisms enable the MVC architecture 300A to efficiently handle multiple advisory sessions concurrently. The MVC architecture 300A, therefore, enables reliable backend coordination for the advisory commerce system 100.

In certain aspects of the illustrative embodiment of the present invention, the backend MVC architecture 300A begins with user interaction events 302 generated through frontend interfaces of the social commerce platform 102. The user interaction events 302 may correspond to actions such as submitting user constraints, confirming approval of advisory recommendations or initiating consultation sessions. These interactions originate from the frontend module and are transmitted to the backend infrastructure through application programming interfaces. The user interaction events 302 serve as triggers that initiate backend processing within the MVC architecture 300A. By capturing these interaction events, the system 100 ensures that advisory commerce operations are processed in response to user activity.

The interaction event 302 is received by the view layer 304 of the backend MVC architecture 300A. In the Node.js environment, the view layer 304 represents request-handling interfaces responsible for receiving HTTP or API requests from frontend clients. The view layer 304 parses incoming request data and forwards the request to the appropriate backend controllers. Although the view layer 304 does not implement business logic, it acts as a gateway for user-generated inputs entering the backend module. The view layer 304, therefore, enables structured communication between frontend user interfaces and backend processing components.

After receiving the request, the view layer 304 forwards the interaction to the controller 308 through a communication step represented by reference numeral 306. This step 306 represents the transmission of event information from the view layer 304 to the controller 308. The controller 308 acts as a central orchestration component responsible for interpreting the received request. The controller 308 determines the appropriate backend operations required to process the request. For example, the controller 308 may initiate consultation session updates, process advisory interaction records or validate approval events associated with advisory recommendations.

The controller 308 performs application-level processing and coordinates communication between the view layer 304 and the model layer 310. Within the Node.js backend environment, the controller 308 may implement asynchronous functions that process incoming API requests and route them to appropriate data-handling services. The controller 308 may also perform validation of input data received from the frontend module. By centralizing request-handling logic, the controller 308 ensures consistent processing of advisory commerce operations across the system.

Following interpretation of the request, the controller 308 transmits data processing instructions to the model 310 through a communication step represented by reference numeral 309. This step represents the operation in which the controller 308 updates or queries application data stored in backend repositories. The model 310 contains the core data structures and persistence logic associated with the advisory commerce system 100. The communication step 309 ensures that user-generated events and advisory interactions are properly reflected within the backend data model.

The model layer 310 represents the data management component of the MVC architecture 300A. The model layer 310 may include database schemas, object models and data repositories associated with consultation sessions, advisory recommendations, approval events and transaction records. Within a Node.js environment, the model layer 310 may interact with relational databases, NoSQL databases or distributed data stores. By maintaining structured records of advisory commerce interactions, the model layer 310 supports reliable transaction attribution and commission calculation processes.

The model layer 310 processes data updates requested by the controller 308 and may perform operations such as inserting new consultation session records, updating advisory interaction data or retrieving transaction information. Once the model layer 310 completes the required data processing tasks, it generates a response indicating that the data state has been modified. This change in data state forms the basis for notifying other components within the MVC architecture 300A that new information is available.

Following completion of data processing, the model layer 310 notifies the view layer 304 that the underlying data has changed through a communication step represented by reference numeral 312. This notification step 312 ensures that the system components remain synchronized with the updated application state. In certain implementations, this communication step 312 may be implemented through asynchronous callbacks or event-driven mechanisms within the Node.js framework. As a result, backend responses can be delivered efficiently to the requesting client interface.

Upon execution of the notification step 312, the view layer 304 retrieves updated data from the model layer 310 through a data retrieval step represented by reference numeral 314. During this step 314, the view layer 304 queries the model layer 310 to obtain the latest state of application data. The retrieved data may include updated consultation session information, advisory recommendation records or approval event confirmations. This step 314 ensures that the response returned to the frontend reflects the most current system state.

The view layer 304 then prepares a response payload containing the retrieved data and transmits the response back to the frontend interface that initiated the interaction. The response may include structured data such as JSON objects representing consultation session updates, advisory recommendation status or confirmation of recorded approval events. By transmitting updated information to the frontend interface, the backend system maintains synchronization between user interfaces and backend data repositories.

The MVC architecture 300A further benefits from the asynchronous and event-driven capabilities of the Node.js runtime environment. Node.js enables non-blocking execution of backend operations, allowing the system to handle multiple advisory interactions and transaction attribution processes concurrently. This capability is particularly beneficial in advisory commerce platforms where numerous users and advisors may interact simultaneously. The Node.js environment, therefore, enhances the scalability and responsiveness of the backend module.

In certain aspects of the illustrative embodiment of the present invention, the MVC architecture 300A may also incorporate middleware layers that perform authentication, request validation or logging operations before requests are processed by the controller 308. These middleware layers can intercept requests received by the view layer 304 and enforce security or validation policies. Such mechanisms help ensure that advisory interactions and consultation session updates originate from authenticated users and authorized advisors.

Through the coordinated operation of the view layer 304, controller 308 and model layer 310, the MVC architecture 300A provides a structured backend framework for the advisory commerce system 100. The architecture enables efficient processing of consultation session events, advisory interactions and transaction-related data updates. By separating request handling, application logic and data management responsibilities, the MVC architecture 300A improves the maintainability and scalability of backend services.

Overall, the MVC architecture 300A implemented in the Node.js backend module provides a robust infrastructure for managing advisory commerce workflows within the advisory commerce system. The MVC architecture 300A ensures that user interactions received through frontend interfaces are processed efficiently, recorded within backend data models and reflected in system responses. Consequently, the backend module supports reliable coordination between advisory interactions, consultation session records and commercial transaction attribution processes.

FIG. 3B illustrates a Laravel architecture 300B of the backend module of the advisory commerce system in accordance with the illustrative embodiment of the present invention. The Laravel architecture 300B provides a structured backend framework that supports consultation session management, advisory interaction processing, transaction attribution and commission generation within the system.

The Laravel implements a Model–View–Controller (MVC) framework that separates request handling, application logic and data management into independent components. This modular architecture improves maintainability, scalability and development efficiency. The Laravel framework further enables secure routing, middleware processing and database interaction required for advisory commerce operations. Through this Laravel architecture 300B, backend services coordinate interactions between the social commerce platform 102 and external commerce platforms 138.

In certain aspects of the illustrative embodiment of the present invention, the backend processing begins with user interaction events 302 generated by frontend components of the social commerce platform 102. These events may correspond to user actions such as initiating a consultation session, submitting user constraints, approving advisory recommendations or requesting advisory content. The frontend interface transmits these interaction events to the backend through HTTP requests or application programming interfaces. The Laravel routing mechanisms receive the incoming request and determine the appropriate controller responsible for processing the event. The interaction event 302 therefore, serves as the initial trigger for backend processing within the Laravel architecture 300B.

The interaction event 302 is received through the view layer 304 of the Laravel architecture 300B. In certain implementations, the view layer 304 may include presentation templates such as Blade templates or API response handlers responsible for formatting responses returned to the frontend module. The view layer 304 primarily serves as an interface between the backend logic and the frontend application. Although the view layer 304 does not perform business logic, it organizes data for presentation and prepares responses that are transmitted to the requesting client application.

After receiving the request, the view layer 304 forwards the interaction to the controller 308 through a communication process represented by reference numeral 306. The step 306 represents the routing of request data from the view layer 304 to the appropriate controller method within the Laravel architecture 300B. Laravel routing definitions determine which controller should process the incoming request. The controller 308 therefore functions as the central processing unit responsible for coordinating backend operations related to the request.

The controller 308 processes the received interaction and determines the appropriate actions required to fulfil the request. In the context of the advisory commerce system 100, the controller 308 may initiate creation of consultation sessions, record advisory interactions, validate approval events or coordinate transaction attribution processes. The controller 308 also performs input validation and authentication checks to ensure that the request originates from an authorized user or authenticated advisor. Through these operations, the controller 308 manages application-level logic within the backend module.

Following the interpretation of the request, the controller 308 communicates with the model layer 310 through an operation represented by reference numeral 309. The step 309 represents the transmission of data processing instructions from the controller 308 to the model layer 310. In Laravel architecture 300B, the model typically corresponds to database entities represented through Eloquent ORM objects. The model layer 310 therefore represent database tables or data structures associated with consultation sessions, advisory interactions, approval events and purchase transactions.

The model layer 310 performs data-related operations such as retrieving, inserting or updating records within backend databases. For example, the model layer 310 may create new consultation session records, store captured user constraints or update approval event data associated with advisory recommendations. Laravel’s Eloquent ORM simplifies these operations by providing object-oriented access to database records. Through this abstraction layer, the system can efficiently manage complex data structures associated with advisory commerce interactions.

Once the model layer 310 completes the requested data processing tasks, the updated data state is made available to the rest of the backend architecture. The model layer 310 maintains structured records that may include consultation session identifiers, advisor identifiers, advisory interaction logs and transaction data associated with external commerce platforms 138. Maintaining these structured records ensures that the backend module can reliably track advisory interactions and associate them with downstream purchase transactions.

After updating the data state, the model layer 310 notifies the view layer 304 that the data has changed through a communication step represented by reference numeral 312. In the Laravel architecture 300B, this step may involve returning processed data from the model layer 310 to the controller 308, which then prepares a response through the view layer 304. The notification ensures that the response transmitted to the frontend reflects the updated system state. This mechanism ensures synchronization between backend data repositories and frontend user interfaces.

Following notification of data changes, the view layer 304 retrieves the processed data from the model layer 310 through a data access operation represented by reference numeral 314. The retrieved data may include consultation session details, advisory recommendation records or confirmation of approval events. The view layer 304 formats this data into a structured response suitable for transmission to the frontend module. In Laravel applications, the response may be returned as JSON data through API responses or rendered using Blade templates.

The prepared response is then transmitted to the frontend interface that initiated the request. This response may confirm successful recording of advisory interactions, provide updated consultation session information or return results of transaction attribution operations. By delivering updated data to the frontend module, the backend architecture maintains synchronization between user interfaces and backend processing components. This interaction ensures a seamless advisory commerce experience for both users and advisors.

In certain aspects of the illustrative embodiment of the present invention, the Laravel architecture 300B may also incorporate middleware components that intercept incoming requests before they reach the controller 308. These middleware components may perform authentication, authorization or request validation functions. For example, middleware may verify that a request originates from an authenticated advisor before allowing the controller308 to process advisory recommendations. Such security mechanisms ensure the integrity and reliability of advisory interactions within the system.

Additionally, Laravel’s service container and dependency injection mechanisms may assist the controller 308 in accessing services required for backend operations. These services may include consultation session management services, transaction attribution services or commission calculation modules. By organizing backend services through dependency injection, the Laravel architecture promotes modular system design and simplifies maintenance of the backend module.

Through the coordinated operation of the view layer 304, controller 308 and model layer 310, the Laravel architecture 300B provides a scalable and maintainable backend framework for the advisory commerce system. The architecture efficiently processes frontend requests, records advisory interactions, manages consultation session data and supports transaction attribution mechanisms. By separating presentation, business logic and data management responsibilities, the architecture improves reliability and scalability of backend operations.

Overall, the Laravel architecture 300B enables efficient management of backend processes associated with advisory commerce interactions. The architecture ensures that consultation session events, advisory recommendations, approval events and transaction data are processed and stored in a consistent manner. As a result, the backend module of the advisory commerce system 100 can reliably support advisory-driven commerce workflows and maintain accurate records of interactions leading to external commercial transactions.

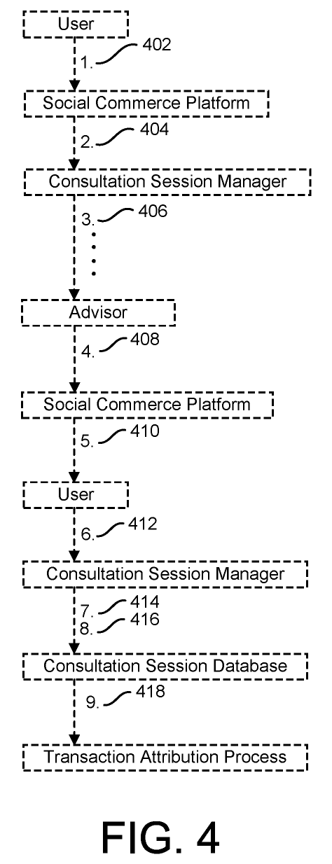

FIG. 4 illustrates a consultation workflow 400 of the advisory commerce system in accordance with the illustrative embodiment of the present invention. The consultation workflow 400 describes a structured sequence of interactions through which a user communicates with an advisor within a social commerce platform to obtain personalized product or service recommendations. The workflow 400 enables advisory interactions to be captured, validated, and recorded within a consultation session environment. By maintaining structured records of advisory communications and user responses, the workflow 400 enables the system to later associate advisory activity with external commercial transactions. The consultation workflow 400, therefore, forms an important interaction process within the advisory commerce system 100.

The consultation workflow 400 begins at step 402 when a user initiates a request for advice within the social commerce platform 102. The user may request assistance in selecting products, assembling outfits, or identifying items that match particular preferences or contextual needs. This request may be submitted through an interface of the social commerce platform 102 such as a messaging interface, consultation request form, or recommendation prompt. The system 100 receives the request and prepares to initiate a consultation session between the user and an advisor.

At step 404, the system creates a consultation session corresponding to the user request. The consultation session establishes a structured communication environment through which advisory interactions between the user and an advisor may occur. In certain aspects of the illustrative embodiment of the present invention, the consultation session is assigned a unique session identifier that enables tracking and management of the advisory interaction. The session identifier further enables the system 100 to associate subsequent user responses and advisory recommendations with the same consultation session.

Following creation of the consultation session, the workflow 400 proceeds to step 406 in which the user transmits constraints and preference information relevant to the consultation request. Such constraints may include parameters that guide the advisor in preparing relevant recommendations. The transmitted information may include budget constraints, product size information, preferred brands, product categories, and contextual requirements such as events, seasonal conditions, or specific usage scenarios. The system 100 records these constraints as part of the consultation session data.

The captured user constraints enable the advisor to better understand the requirements and expectations of the user. By storing this information within the consultation session record, the system ensures that the advisory recommendations provided during the session remain aligned with the user’s preferences. The constraint information may also be referenced throughout the consultation to refine recommendations. This step 406 improves the personalization and relevance of advisory interactions within the platform.

After receiving the user constraints, the workflow proceeds to step 408 in which the advisor provides product or outfit recommendations based on the received constraints. The advisor may review the user’s preferences and identify products, services, or curated selections that correspond to the user’s requirements. These recommendations may include individual products, bundled items, curated outfit combinations, or other forms of advisory content relevant to the user’s request.

The generated recommendations are communicated through the platform interface and recorded as advisory interactions within the consultation session. In certain aspects of the illustrative embodiment of the present invention, the advisor may provide multiple recommendation options so that the user can evaluate different alternatives. The recommendations may also include product descriptions, pricing information, or purchase links that guide the user toward external commerce platforms 138 where the items may be acquired.

The workflow then proceeds to step 410 where the recommendations are displayed to the user within the social commerce platform 102 interface. The user may review the recommendations, evaluate the suggested products or outfit combinations, and provide feedback to the advisor. The system 100 ensures that the displayed recommendations correspond to the advisory content generated during the consultation session. This step 410 enables the user to visually evaluate and interact with the suggested items.

During this step 410, the user may request modifications, ask for additional recommendations, or clarify requirements based on the displayed suggestions. This interactive exchange allows the advisor to refine the recommendations until a suitable option is identified. The consultation session therefore supports iterative advisory interactions that improve recommendation quality and relevance.

Once a suitable recommendation is identified, the workflow proceeds to step 412 where a customer approval event is generated. The customer approval event occurs when the user explicitly confirms acceptance of the advisor’s recommendation. Such approval may occur through an interface action such as selecting a recommended product, confirming an item, or indicating intent to proceed with the suggested purchase.

After the approval action is performed, the system 100 proceeds to step 414 where the approval event is recorded within the consultation session record. Recording the approval event provides verifiable evidence that the user accepted the advisory recommendation during the consultation. The recorded approval event becomes an important reference point for subsequent transaction attribution processes implemented by the system 100.

Following recording of the approval event, the workflow proceeds to step 416 in which the consultation session data is timestamped. Timestamping ensures that the consultation session, advisory interactions, and approval event are chronologically documented. These timestamps enable the system to later verify the temporal relationship between advisory interactions and any subsequent purchase transactions.

Finally, at step 418, the consultation session data is stored within the system repository for later processing and transaction association. The stored session data may include user constraints, advisory recommendations, approval events, and timestamp information. This stored information allows the system to later determine whether a purchase transaction detected within an external commerce platform corresponds to the previously recorded advisory session.

The advisory commerce system 100 enables structured consultation interactions between users and advisors. The workflow ensures that advisory interactions are captured, validated, and preserved within a consultation session record. By maintaining these structured records, the system 100 establishes a reliable foundation for associating advisory guidance with later commercial transactions occurring within external commerce environments.

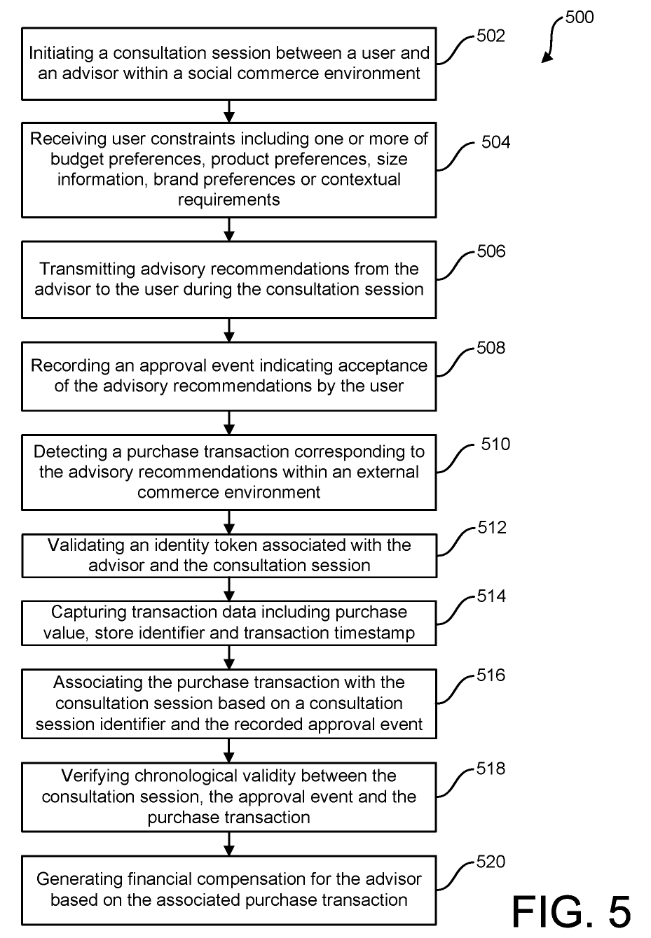

FIG. 5 illustrates a method 500 for associating an advisory interaction with an external commercial transaction in accordance with the illustrative embodiment of the present invention. The method 500 describes a workflow through which advisory interactions occurring within a social commerce environment are programmatically associated with purchase transactions occurring within the external commerce platform 138. The method 500 enables the system 100 to identify whether a purchase transaction was influenced by recommendations provided by an advisor. By recording advisory interactions, approval events and purchase transactions, the method 500 establishes a verifiable relationship between advisory activities and downstream commercial outcomes. The method 500 thereby enables reliable attribution of external transactions to advisory interactions.

The method 500 begins at step 502 by initiating a consultation session between a user and an advisor within a social commerce environment. The consultation session establishes an interactive advisory context in which the user can seek recommendations from the advisor. During this session, communication channels are opened that allow the exchange of messages, product suggestions and contextual guidance. The consultation session may be uniquely identified through a session identifier generated by the system 100. This session identifier enables the system to track advisory interactions associated with the session.

Further, the method includes a step 504 where the system 100 receives user constraints, including one or more of budget preferences, product preferences, size information, brand preferences or contextual requirements. These constraints provide contextual information that assists the advisor in generating relevant recommendations. The constraints may be provided through structured input fields or interactive interface elements within the social commerce platform 102. The system 100 stores the received constraint data as part of the consultation session record. Capturing these constraints ensures that advisory recommendations align with the user’s purchasing requirements.

Following the capture of user constraints, the method 500 further includes a step 506 in which advisory recommendations are transmitted from the advisor to the user during the consultation session. The recommendations may include product suggestions, curated item lists, outfit combinations or other advisory content. These recommendations may be transmitted through messaging interfaces or recommendation panels within the social commerce platform 102. The system 100 records the advisory interactions associated with these recommendations. Recording the advisory interactions ensures traceability of the advisory guidance provided during the consultation session.

Once the advisory recommendations have been presented, the method 500 proceeds to step 508, where the system 100 records an approval event indicating acceptance of the advisory recommendations by the user. The approval event may occur when the user explicitly confirms or selects a recommended product or item. The system 100 records the approval event together with the consultation session identifier and advisory interaction records. The approval event, therefore, represents confirmation that the user intends to act upon the recommendation provided by the advisor. This step 508 provides an important reference point for later transaction attribution.

After recording the approval event, the method 500 proceeds to step 510, which involves detecting a purchase transaction corresponding to the advisory recommendations within an external commerce environment. The purchase transaction may occur within a third-party e-commerce platform or merchant-operated commerce website. The system 100 detects the transaction through integration mechanisms such as embedded plugins or transaction monitoring interfaces. Detection of the purchase transaction enables the system 100 to identify when a user proceeds to complete a purchase associated with the advisory recommendation.

Upon detection of the purchase transaction, the method 500 continues to step 512, where the system validates an identity token associated with the advisor and the consultation session. The identity token serves as a reference mechanism linking the purchase transaction with the advisory interaction that occurred during the consultation session. Validation of the identity token ensures that the detected purchase corresponds to a legitimate advisory session and an authenticated advisor. This validation step 512 prevents unauthorized or unrelated transactions from being attributed to advisory interactions.

Following the token validation, the method 500 proceeds to step 514 in which the system captures transaction data, including purchase value, store identifier and transaction timestamp. The captured transaction data provides detailed information about the detected purchase transaction. Such data may include product identifiers, transaction identifiers and other metadata associated with the purchase. The system 100 records the captured transaction data for subsequent analysis and attribution. Capturing this information enables the system 100 to evaluate whether the transaction should be linked to the advisory interaction.

After capturing the transaction data, the method 500 performs step 516, which involves associating the purchase transaction with the consultation session based on a consultation session identifier and the recorded approval event. During this step 516, the system 100 correlates the transaction data with previously recorded consultation session records. The association is performed by matching identifiers and verifying that the transaction corresponds to recommendations accepted by the user. Establishing this association enables the system 100 to link the purchase transaction to the advisory interaction that influenced the purchasing decision.

The method 500 then proceeds to step 518, where the system 100 verifies chronological validity between the consultation session, the approval event and the purchase transaction. This verification step 518 ensures that the purchase transaction occurred after the advisory recommendation and the approval event. Chronological validation confirms that the advisory interaction logically preceded the commercial transaction. If the chronological relationship is not satisfied, the system 100 may reject the attribution of the transaction. This step 518, therefore, maintains the integrity of the advisory-to-transaction linkage.

In certain aspects of the illustrative embodiment of the present invention, the chronological verification step 518 may involve comparing timestamps associated with the consultation session, approval event and purchase transaction. The system 100 evaluates whether the timestamps follow a logical sequence, indicating that the advisory interaction occurred prior to the purchase. This evaluation ensures that the advisory recommendation was capable of influencing the purchasing decision. By enforcing this temporal validation, the system 100 prevents incorrect attribution of unrelated purchase transactions.

Once the chronological relationship has been validated, the method 500 proceeds to step 520, where the system 100 generates financial compensation for the advisor based on the associated purchase transaction. The compensation may be determined using predefined commission rules or merchant-specific compensation models. The system 100 calculates a commission value corresponding to the purchase transaction and records the compensation event. This step 520 ensures that the advisor receives appropriate compensation for recommendations that result in successful purchase transactions.

In certain aspects of the illustrative embodiment of the present invention, the generated financial compensation may be recorded within a commission ledger that maintains a historical record of advisory-linked transactions. The ledger may store transaction identifiers, commission values, payout status and advisor identifiers associated with each transaction. Maintaining such records ensures transparency and traceability of compensation events. The ledger also enables administrators or system operators to analyze advisory performance and track commission payouts.

Through the sequence of steps described above, the method 500 illustrated in FIG. 5 enables the advisory commerce system to establish a reliable association between advisory interactions and external purchase transactions. By capturing advisory interactions, approval confirmations and transaction data, the method 500 ensures that advisory-driven commercial activity can be accurately attributed. This process allows advisors to influence purchasing decisions while enabling the system to track and reward successful advisory outcomes. Consequently, the method 500 supports the operation of advisory-based social commerce platforms 102 in which expertise contributes directly to commercial transactions.

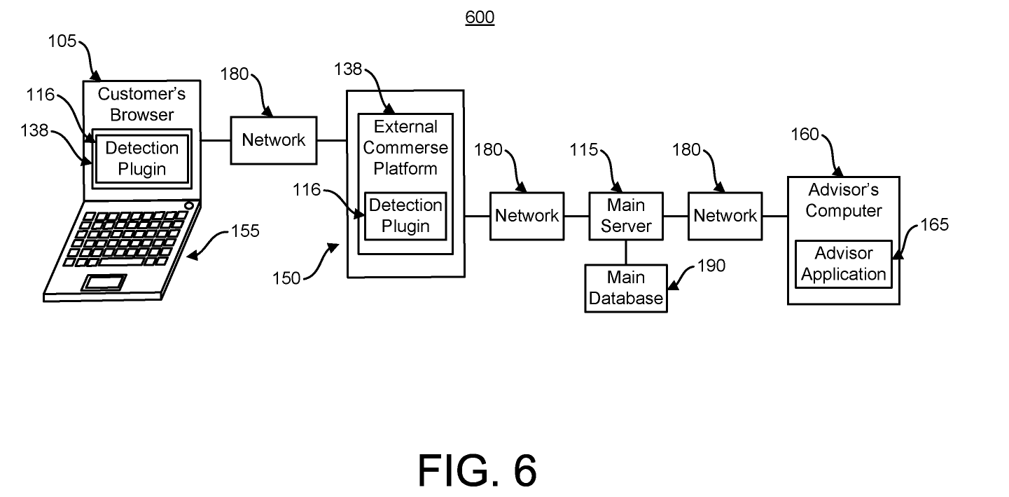

Referring to FIG. 6, an illustrative embodiment of the system 600 of the present invention is schematically depicted. It comprises a main server 115 connected to a main database 190. External commerce platform 138 consisting of at least one webpage, and typically of multiple webpages, is hosted on a client server 150. A prospective purchaser, often referred to as a customer or user, from her computer 155 opens an Internet browser 105 and opens a webpage of the external commerce platform 138, at least one webpage of which has the detector plugin 116 on it. The computer 155, which could be any computing device such as a laptop, desktop, server, smartphone, tablet, etc., is connected via the network 180 with the client server 150. An advisorr computer 160, which could be any computing device such as a laptop, desktop, server, smartphone, tablet, etc., is connected to the main server 115 via the network 180. An advisor application 165 is stored and later runs on the advisor computer 160.

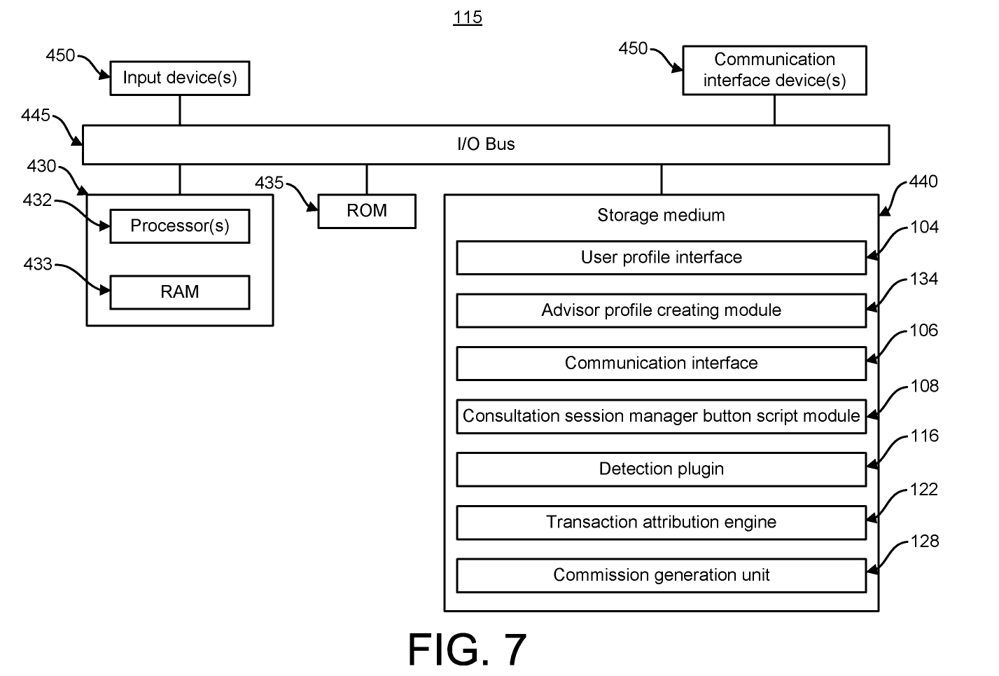

Referring to FIG. 7, the main server 115 may be a special purpose or a general purpose computer in some embodiments. The main server 115 comprises at least one processing unit 430 which comprises one or more processors 432 and random access memory (RAM) 433. They are electronically connected to other components of the main server 115 through the input/output bus 445. The main server 115 is capable of receiving signals from at least one input device 450, which could comprise a keyboard, a mouse, a touch input screen, or an audio recognition device, etc., and is electronically connected to it through the input/output bus 445. At least one storage medium 440, which is also electronically connected to other components of the main server 115 through the input/output bus 445, stores different software programs and instructions, including user profile interface 104, advisor profile creating module 134, communication interface 106, consultation session manager 108, detection plugin 116, transaction attribution engine 122, commission generation unit 128, and other data.

The one or more processors 432 may be in a form of a central processing unit (CPU); a multi-processor unit (MPU); an ARM processor; a controller; a programmable logic device; or a similar device. In some embodiments, the at least one processing unit 430 includes one or more processors operatively connected to one or more of a RAM, ROM, and machine-readable storage medium. The one or more processors of the at least one processing unit 430 receive instructions stored by the one or more of a RAM, ROM, and machine-readable storage medium via a bus, and the one or more processors execute the received instructions. In some embodiments, the at least one processing unit 430 is an ASIC (Application-Specific Integrated Circuit) or a SoC (System-on-Chip). Examples of the at least one input device 450 include tactile devices such keyboards, keypads, foot pads, touch screens, and/or trackballs; non-contact devices such as audio input devices; motion sensors and motion capture devices that the main server 115 can use to receive inputs from a client or another user, when the client interacts with the main server 115; physiological sensors that monitor the physiology of the user; environmental sensors, accelerometers, or location sensors that monitor the physical environment of the main server 115.

The communication interface devices 438 provide one or more wired or wireless interfaces for communicating data and commands between the main server 115 and other devices that may be included in the online broadcasting system 100. Such wired and wireless interfaces include, but are not limited to: a Universal Serial Bus (USB) interface, a Bluetooth interface, a Wi-Fi interface, an Ethernet interface, a Near Field Communication (NFC) interface, a plain old telephone system (POTS) interface, a cellular or satellite telephone network interface, and the like.

In various embodiments, the at least one machine-readable storage medium 440 is one of a (or a combination of two or more of) a hard drive, a flash drive, a DVD, a CD, a flash storage, a solid state drive, a ROM, an EEPROM, and the like, and removable media such as, but not limited to, a USB memory device, an optical CD ROM, magnetic media such as tape and disks, and the like.

The at least one machine-readable storage medium 440 stores machine-executable instructions for various components of the main server 115, such as but not limited to: an operating system, one or more device drivers, one or more application programs including but not limited to an interactive application, and software modules and data for use by the one or more processors 432 to provide the features of a controller as described herein. In operation, the machine-executable instructions are loaded into RAM 433 from the at least one machine-readable storage medium 440, the ROM 435 or any other storage location. The respective machine-executable instructions are accessed by the one or more processors 432 via the bus 445, and then executed by the one or more processors 432. Data used by the one or more processors 432 are also stored in RAM 433, and the one or more processors 432 access such data during execution of the machine-executable instructions. Execution of the machine-executable instructions causes the one or more processors 432 to control the main server 115 to provide the features as described herein.

Network 180 may be the Internet, LAN, WAN, Ethernet or other network. Other computing devices in the system 600 such as the client server 150, the customer computer 155, the advisor computer 160, etc. all have one or more of the components of the main server 115 as depicted and described in FIG. 7.

We claim:

1. An advisory commerce system, comprising:
a social commerce platform, wherein the social commerce platform comprises:
a user profile interface for creating and storing a user profile comprising one or more of a name, preferences, likes, dislikes and budgets of one or more users;
an advisor profile creating module for creating an advisor profile comprising a name, a ConsultantID, an authentication status, an influence expertise and a guidance capability of one or more authenticated advisors; and
a communication interface for enabling exchange of recommendations and communications between the one or more users and the one or more authenticated advisors;
a consultation session manager communicatively coupled with the communication interface for creating and managing a consultation session between a user and an authenticated advisor selected by the user from the one or more authenticated advisors, wherein the consultation session manager comprises:
a constraint capture module for receiving and storing a plurality of user constraints provided by the user;
an advisory interaction recorder for recording an advisory interaction between the user and the authenticated advisor during the consultation session for generating a plurality of advisory recommendations for the user;
an approval recording module for recording an approval event indicating acceptance of one or more of the plurality of advisory recommendations; and
a detection plugin deployable within an external commerce platform and in communication with the social commerce platform and the consultation session manager, wherein the detection plugin comprises:
a token validation module for validating an identity token associated with the authenticated advisor and the consultation session in real-time; and
a transaction capture module for capturing a transaction data comprising a purchase value, a store identifier and a transaction timestamp along with the identity token to initiate a purchase for the user on the external commerce platform;
a transaction attribution engine communicatively coupled to the detection plugin for associating the transaction data and the purchase with the consultation session using an advisory-causality link, wherein the transaction attribution engine comprises:
a session correlation module for matching the transaction data with a consultation session identifier and the approval event; and
a verification module for verifying a chronological validity between the consultation session, the approval event and the purchase; and
a commission generation module connected to the transaction attribution engine, wherein the commission generation module comprises:
a commission calculation module for calculating a commission value based on a set of predefined rules and the chronological validity; and
a commission ledger module for recording the commission value with a transaction identifier and a payout status to generate a financial compensation for the authenticated advisor and enabling the user to perform shopping on the external commerce platform.

2. The advisory commerce system of claim 1, wherein the advisory-causality link comprises the consultation session identifier, the approval event and an identity of the advisor.

3. The advisory commerce system of claim 1, wherein the detection plugin comprises:
a relationship manager configured to establish a verifiable causal relationship between the authenticated advisor and the user based on the identity token allowing the authenticated advisor to provide one or more suggestions to the user;
a purchase detector configured to detect the purchase executed by the user based on the one or more suggestions of the advisor; and
a link generator to generate the advisory-causality link between the advisor and the user.

4. The advisory commerce system of claim 1, wherein the verification module verifies the chronological validity between the consultation session, the approval event and the purchase.

5. The advisory commerce system of claim 1, wherein the transaction attribution engine rejects attribution of the purchase when the chronological validity between the consultation session, the approval event and the purchase transaction is not satisfied.

6. The advisory commerce system of claim 1, wherein the transaction attribution engine correlates the purchase with the consultation session using the consultation session identifier within the identity token.

7. The advisory commerce system of claim 1, wherein the token validation module verifies a cryptographic signature associated with the identity token of the advisor.

8. The advisory commerce system of claim 1, wherein the transaction attribution engine generates a transaction record linking the consultation session identifier, Consultant ID and the transaction data.

9. The advisory commerce system of claim 1, wherein the transaction attribution engine stores attributed transaction records in a tamper-resistant data structure.

10. The advisory commerce system of claim 1, wherein the transaction attribution engine prevents duplicate attribution of the purchase.

11. The advisory commerce system of claim 1, wherein the transaction attribution engine associates the purchase with advisory recommendations recorded during the consultation session.

12. The advisory commerce system of claim 1, wherein the identity token comprises at least one of a cryptographically signed session token, an encrypted browser cookie, or a URL parameter with signature validation.

13. The advisory commerce system of claim 1, wherein the detection plugin transmits the transaction data to the transaction attribution engine through a secured application programming interface.

14. The advisory commerce system of claim 1, wherein the detection plugin performs a real-time API lookup during checkout of the external commerce platform to validate the consultation session identifier.

15. The advisory commerce system of claim 1, wherein the detection plugin operates as a browser extension configured to intercept DOM elements of the external commerce platform to identify the transaction data and the purchase.

16. The advisory commerce system of claim 1, wherein the transaction attribution engine validates authenticity of the purchase using a captured transaction metadata.

17. The advisory commerce system of claim 1, wherein the commission generation module records the commission value together with a transaction identifier and the identity of the advisor.

18. The advisory commerce system of claim 1, wherein the commission calculation module determines the financial compensation based on store-specific commission parameters.

19. A method for associating an advisory interaction with an external commercial transaction, the method comprising:
initiating a consultation session between a user and an advisor within a social commerce environment;
receiving user constraints including one or more of budget preferences, product preferences, size information, brand preferences or contextual requirements;
transmitting advisory recommendations from the advisor to the user during the consultation session;
recording an approval event indicating acceptance of the advisory recommendations by the user;
detecting a purchase transaction corresponding to the advisory recommendations within an external commerce environment;
validating an identity token associated with the advisor and the consultation session;
capturing transaction data including purchase value, store identifier and transaction timestamp;
associating the purchase transaction with the consultation session based on a consultation session identifier and the recorded approval event;
verifying chronological validity between the consultation session, the approval event and the purchase transaction; and
generating financial compensation for the advisor based on the associated purchase transaction.

20. The method of claim 19, wherein the method prevents generation of the financial compensation when the purchase transaction is detected without a corresponding prior approval event associated with the consultation session.
